(19) United States
(12) Patent Application Publication
(10) Pub. No.: US 2016/0216580 A1
(43) Pub. Date: Jul. 28, 2016

(54) DISPLAY APPARATUS AND COLOR FILTER

(71) Applicant: ORTUS TECHNOLOGY CO., LTD., Hino (JP)

(72) Inventor: Hiromitsu Ishii, Hino (JP)

(73) Assignee: ORTUS TECHNOLOGY CO., LTD., Hino (JP)

(21) Appl. No.: 15/091,231

(22) Filed: Apr. 5, 2016

Related U.S. Application Data
(63) Continuation of application No. PCT/JP2014/077720, filed on Oct. 17, 2014.

(30) Foreign Application Priority Data
Oct. 18, 2013 (JP) 2013-217874

(51) Int. Cl. G02F 1/1343; G02F 1/1335

(52) U.S. Cl. CPC G02F 1/134309; G02F 1/133512; G02F 1/133514; G02F 2001/134345

(57) ABSTRACT

A display apparatus includes a first pixel and a second pixel, each having subpixels of three colors, red, green, and blue. Six subpixels included in the first and second pixels are arranged in two rows by three columns, and constitute a repetition unit to constitute a display portion. An aspect ratio of a vertical length to a horizontal length of the subpixel is approximately 3:4. An aspect ratio of a vertical length to a horizontal length of the repetition unit is approximately 1:2.

### CROSS-REFERENCE TO RELATED APPLICATIONS

This application is a Continuation Application of PCT Application No. PCT/JP2014/077720, filed Oct. 17, 2014, and based upon and claiming the benefit of priority from Japanese Patent Application No. 2013-217874, filed Oct. 18, 2013, the entire contents of all of which are incorporated herein by reference.

### BACKGROUND OF THE INVENTION

1. Field of the Invention

The present invention relates to a display apparatus and a color filter.

2. Description of the Related Art

For example, a display apparatus using a liquid crystal realizes color display using a color filter. A common color filter consists of the three primary colors of light; red (R), green (G) , and blue (B). A set of three adjacent colors, R, G, and B, is a unit of display (the unit is called a pixel), and a single-color part in one pixel is called a subpixel, and it is a minimum drive unit.

FIGS. 1 to 3 show subpixel arrays for common color filters. The array shown in FIG. 1 is called a stripe array in which the three colors, R, G, and B, make a stripe pattern. The array shown in FIG. 2 is called a mosaic array in which each of R, G, and B subpixels is diagonally arranged. The array shown in FIG. 3 is called a delta array in which each of R, G, and B subpixels is alternately arranged on the apex of a triangle. The color filter arrays are disclosed in, for example, Patent Documents: Jpn. Pat. Appln. KOKAI Publication No. H7-261166 and Jpn. Pat. Appln. KOKAI Publication No. 2008-249895. For the stripe array and the mosaic array, pixels in an approximately square shape are often used, and each subpixel has a rectangular shape with an aspect ratio of a vertical length to a horizontal length 3:1. For the delta array, subpixels having an approximately square shape are used, and a set of R, G, and B has a pattern looking like an isosceles triangle.

The plane shape design and arraying method for subpixels in three colors are significant factors that determine characteristics and performance of a display apparatus. From the viewpoint of a degree of freedom and color reproduction (color mixing performance), it is desired that pixels and subpixels are in a highly-symmetrical shape, such as a circle or hexagon. Since the periodicity in a subpixel array tends to cause moire, an array with less periodicity (an array with less visible periodicity) is desirable. From those viewpoints, the delta array is the most preferable among the arrays shown in FIGS. 1 to 3.

Recently, however, the stripe array has been the most popularly used array in a display apparatus. Since each of scanning lines and signal lines are basically linear in the stripe array, the pixel layout in the stripe array does not result in a reduced aperture ratio, unlike the delta array, for example, which requires treatment of a curved area. Moreover, a color filter is not divided by units of subpixels. Thus, it is easy to manufacture small-sized pixels in the stripe array. Consequently, as a size of subpixels is becoming smaller along with the achievement of a high degree of definition in a display, the stripe array, which is most advantageous in practical performance, has been widely used. Whether or not the periodicity of the subpixel array is visible is a trade-off for a degree of definition; for example, the periodicity is less visible in high-definition pixels.

### BRIEF SUMMARY OF THE INVENTION

According to an aspect of the present invention, there is provided a display apparatus comprising:

a first pixel and a second pixel, each having subpixels of three colors, red, green, and blue, wherein six subpixels included in the first and second

pixels are arranged in two rows by three columns, and constitute a repetition unit to constitute a display portion,

an aspect ratio of a vertical length to a horizontal length of the subpixel is approximately 3:4, and

an aspect ratio of a vertical length to a horizontal length of the repetition unit is approximately 1:2.

According to an aspect of the present invention, there is provided a color filter having a shape and an array in correspondence with the six subpixels recited in the above aspect, and including red filters, green filters, and blue filters.

### BRIEF DESCRIPTION OF THE SEVERAL VIEWS OF THE DRAWINGS

FIG. 1 is a drawing to explain a stripe array;

FIG. 2 is a drawing to explain a mosaic array;

FIG. 3 is a drawing to explain a delta array;

FIG. 4 is a drawing to explain an example of a light shielding target pattern and a light shielding pattern according to the comparative example;

FIG. 5 is a drawing to explain when the light shielding target pattern and the light shielding pattern according to the comparative example are superimposed;

FIG. 6 is a drawing to explain when the light shielding target pattern and the light shielding pattern according to the comparative example are superimposed;

FIG. 7 is a drawing to explain when the light shielding target pattern and the light shielding pattern according to the comparative example are superimposed;

FIG. 8 is a drawing to explain the shape and the array of a plurality of pixels according to the comparative example;

FIG. 9 is a drawing to explain the shape and the array of a plurality of pixels according to the first embodiment;

FIG. 10 is a drawing to explain an example of a light shielding target pattern and a light shielding pattern according to the first embodiment;

FIG. 11 is a drawing to explain when the light shielding target pattern and the light shielding pattern according to the first embodiment are superimposed;

FIG. 12 is a drawing to explain when the light shielding target pattern and the light shielding pattern according to the first embodiment are superimposed;

FIG. 13 is a drawing to explain when the light shielding target pattern and the light shielding pattern according to the first embodiment are superimposed;

FIG. 14 is a plane view of the display apparatus according to the first embodiment;

FIG. 15 is a cross-sectional view of the display apparatus shown in FIG. 14 taken along line A-A′;

FIG. 16 is a cross-sectional view of the display apparatus shown in FIG. 14 taken along line B-B′;

FIG. 17 is a plane view of the display apparatus according to the comparison example;

FIG. 18 is a drawing to explain the shape and array of a plurality of pixels according to the second embodiment; and

FIG. 19 is a drawing to explain the shape and the array of a plurality of pixels according to the third embodiment.

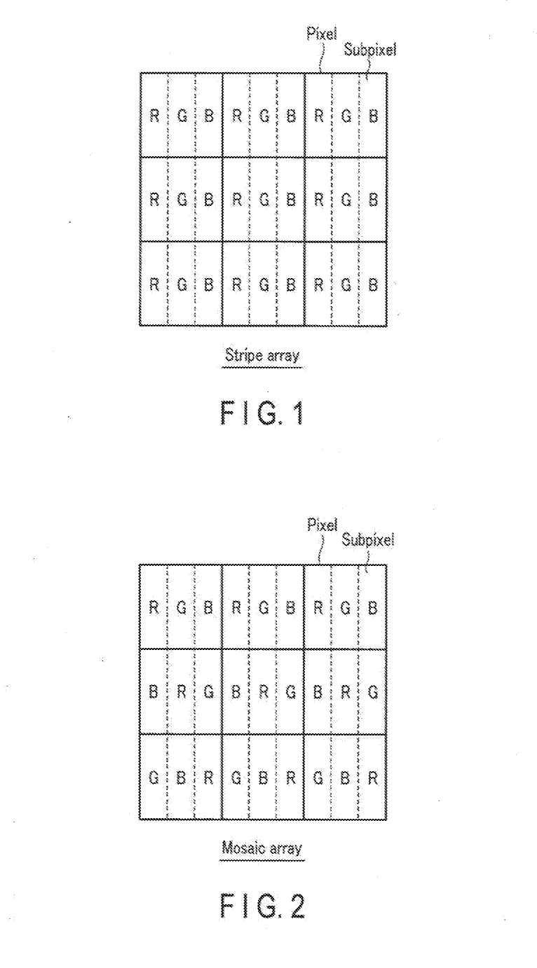

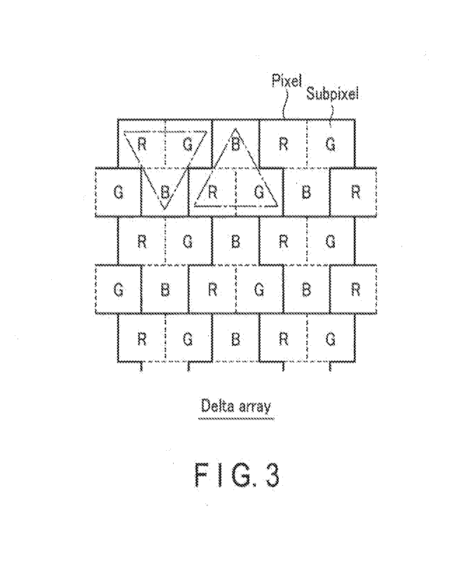

### DETAILED DESCRIPTION OF THE INVENTION

The embodiments of the present invention will be described below with reference to the accompanying drawings. Note that the drawings are schematic and conceptual, and the dimensions, ratios, and the like in the respective drawings are not necessary the same as those in reality. In addition, even the same portion may be shown in a different dimensional relationship or with different ratios in different drawings. Several embodiments to be described below represent examples of apparatuses and methods for embodying the technical idea of the present invention, and the technical idea of the present invention is not specified by the shapes, structures, and layouts of the constituent parts. The technical idea of the present invention can be embodied by modifying constituent elements without departing from the gist of the invention. Note that in the following explanation, the same reference numerals denote elements having the same functions and arrangements, and a repetitive explanation will be made only when necessary.

### [Analysis]

Usually, in a color filter, subpixels are divided by a black matrix BM made of a light shielding material. The purpose of using the black matrix BM is to prevent color mixing between subpixels, to shield light passing through as needed, and to cover a semiconductor element. Ina case of a transmission type display apparatus, an actual display area is defined by an aperture formed when the open area of the black matrix BM and the open area of a light shielding target area to be shielded by the black matrix BM overlap in a plane view. The ratio of the display region to whole subpixels is called an aperture ratio. An aperture ratio becomes maximum when the black matrix having a minimum margin of the black matrix BM and a light shielding target area overlap. The minimum margin is a minimum width that allows necessary light shielding even when the degree of shift between the black matrix BM and the light shielding target area is maximum.

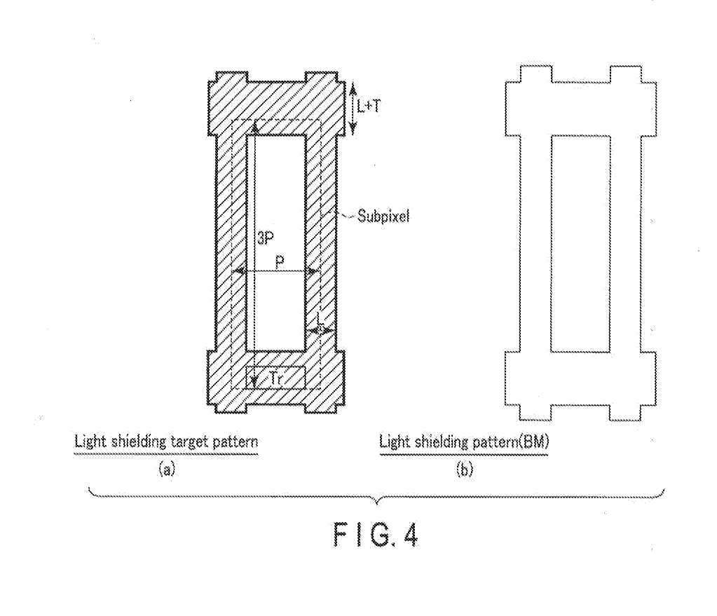

FIG. 4 is a drawing to explain an example of a light shielding target pattern and a light shielding pattern in subpixels in the stripe/mosaic array. A subpixel in the stripe/mosaic array has a shape of a rectangle with an approximate aspect ratio of 3:1.

FIG. 4(a) shows a light shielding target pattern. FIG. 4(b) shows a light shielding pattern consisting of the black matrix BM. A subpixel pitch in the stripe array is denoted as P; in other words, a horizontal length (i.e. , a length of a short side) of a subpixel is P, and a vertical length (i.e., a length of a long side) is 3P. A light shielding width of the long side to shield a wiring part is denoted as L. “Tr” shown in FIG. 4(a) is a switching transistor when a liquid crystal display apparatus is assumed for the embodiment, and the switching transistor is provided on the short side, for example. An increment in a light shielding width to shield the switching transistor is denoted as T, and a light shielding width on the short side to shield the wiring part and the switching transistor is denoted as L+T. The light shielding target pattern is formed on a TFT substrate comprising a switching transistor, for example. The light shielding pattern is formed on a color filter substrate (CF substrate) comprising a color filter, for example.

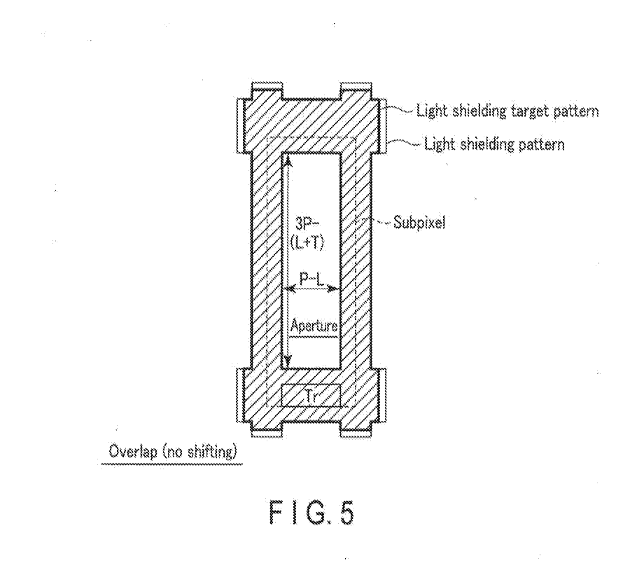

FIG. 5 is a drawing to explain when the light shielding target pattern in FIG. 4(a) and the light shielding pattern in FIG. 4(b) overlap without any shifting. The aperture area becomes maximum when no alignment shift occurs. The aperture area shown in FIG. 5 can be expressed by “(P−L)·(3P−(L+T))”.

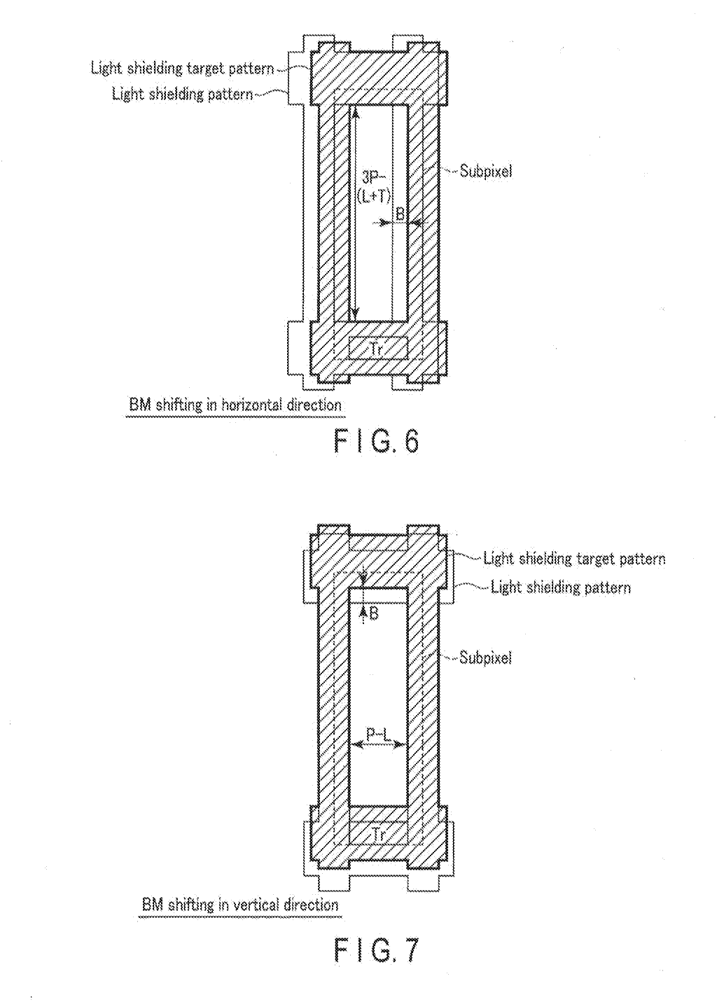

FIG. 6 is a drawing to explain when an alignment shift occurs in the horizontal direction (the black matrix BM is shifted in the horizontal direction). The shifted amount of the black matrix BM is denoted as B. The decreased area of the aperture as shown in FIG. 6 can be expressed by “(3P−(L+T))·B”.

FIG. 7 is a drawing to explain when an alignment shift occurs in the vertical direction (the black matrix BM is shifted in the vertical direction). The decrement in the aperture area in FIG. 7 can be expressed by “(P−L)·B”.

As shown in FIGS. 6 and 7, the light shielding pattern is basically designed in such a manner that the aperture ratio will be reduced in accordance with the shifted amount of the black matrix BM. For this reason, if a subpixel is vertically long with an aspect ratio of 3:1, the aperture ratio will be greatly decreased when an alignment shift occurs in the horizontal direction. Although the decrement in the aperture ratio when an alignment shift occurs in the vertical direction is relatively small, a guarantee value for the aperture ratio in the display apparatus has to be a minimum aperture ratio for a case where maximum shifting occurs in the horizontal direction. For this reason, there is a need of improving the minimum aperture ratio.

In the following, the display apparatus according to the present embodiment will be described. In the description, a liquid crystal display apparatus will be used as an example of a display apparatus.

### First Embodiment

### [1. Structure of Display Portion (Pixel Portion)]

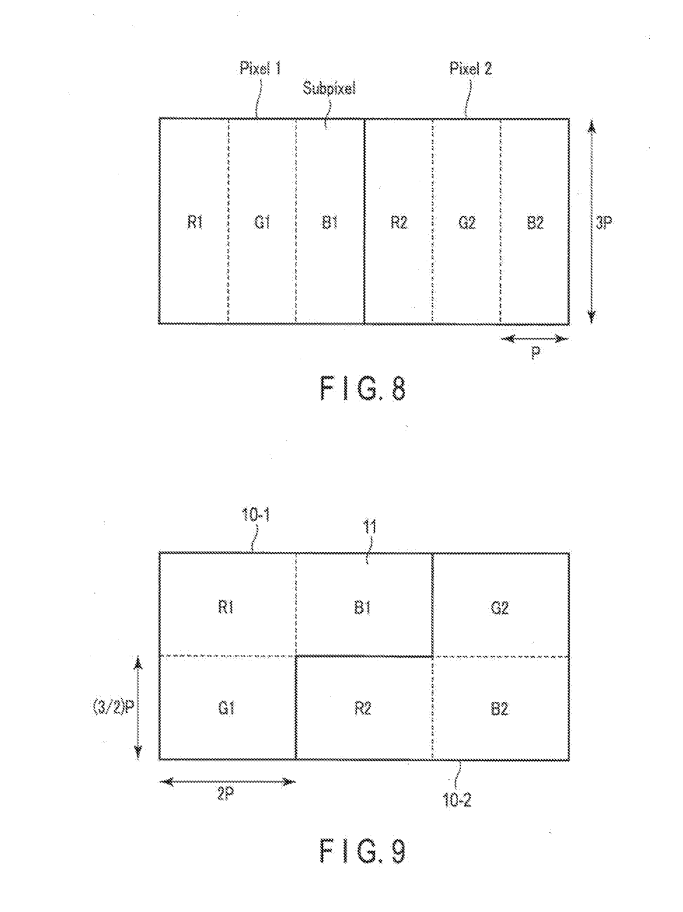

First, the structure of the display portion according to a comparative example will be described. FIG. 8 is a drawing to explain the shape and array of a plurality of pixels according to the comparative example using a stripe array. FIG. 8 shows two pixels (pixel 1 and pixel 2) extracted.

Each pixel consists of R, G, and B subpixels. In the stripe array, subpixels are in a rectangular shape where the aspect ratio is approximately 3:1. If a subpixel pitch in the stripe array is denoted by P, a horizontal length (i.e., a length of the short side) of a subpixel is P, and a vertical length (i.e., a length of the long side) is 3P. In the stripe array, R, G, and B subpixels are combined, making a pixel approximately square in shape. This square is the periodicity of pixels (a repetition unit).

Next, the structure of the display portion of the display apparatus according to the present embodiment will be described. The display portion comprises a plurality of pixels. FIG. 9 is a drawing to explain the shape and the array of a plurality of pixels 10 according to the present embodiment. FIG. 9 shows two pixels (pixel 10-1 and pixel 10-2) extracted. Each pixel 10 consists of R, G, and B subpixels 11.

In the present embodiment, the rectangular shape wherein the aspect ratio is approximately 1:2, which corresponds to two square pixels in the stripe array placed horizontally, is defined as a repetition unit, and the repetition unit is divided into two L-shaped pixels (six subpixels) . More specifically, while the R, G, and B subpixels 11 constitute the pixel 10, the pixels 10-1 and 10-2 are configured in two types of L shapes, and a rectangle made by combining these two types of L-shaped pixels 10-1 and 10-2 is defined as a repetition unit, unlike the stripe array where subpixels in three colors are in line to constitute pixels.

Six subpixels 11 included in a repetition unit are arranged in 2 rows by 3 columns. A plurality of repetition units shown in FIG. 9 is provided for the display portion, and they are arranged in a matrix to comprise the display portion.

In the pixels 10-1 and 10-2 which are repetition units, the red subpixels 11-R1 and 11-R2 are arranged adjacent in a diagonal direction, and the blue subpixels 11-B1 and 11-B2 are arranged adjacent in a diagonal direction. Green subpixels 11-G1 and 11-G2 are arranged diagonally in the remaining corners of the rectangle. In other words, the plurality of subpixels 11 are arranged in such a manner that the subpixels of the same color are not arranged consecutively in each of a row and a column in the repetition unit.

Compared to the subpixels in the stripe array, the vertical length of the subpixel 11 in the present embodiment is half as long, and the horizontal length is twice as long as that of the subpixels in the stripe array; thus, the resulting rectangle's aspect ratio of the vertical length to the horizontal length is approximately 3:4. It should be noted that the word “approximately” added to the aspect ratio in the above description means that there are errors due to manufacturing methods or manufacturing steps. If a subpixel pitch in the stripe array is denoted by P, the horizontal length of a subpixel 11 is 2P, and the vertical length is (3/2)P in the present embodiment. Since the wiring (scanning lines and signal lines) is configured only in straight lines similar to the stripe array, the aperture ratio would not be decreased due to a treatment for a curved part of the wiring as in the delta array. The perimeter of the subpixels in the stripe array is 8P, whereas the perimeter of the subpixels in the present embodiment is 7P. Thus, because of less area occupied by the wiring, the aperture ratio can be expected to be equal to or greater than the aperture ratio in the stripe array.

### [2. Alignment Shift of Black Matrix]

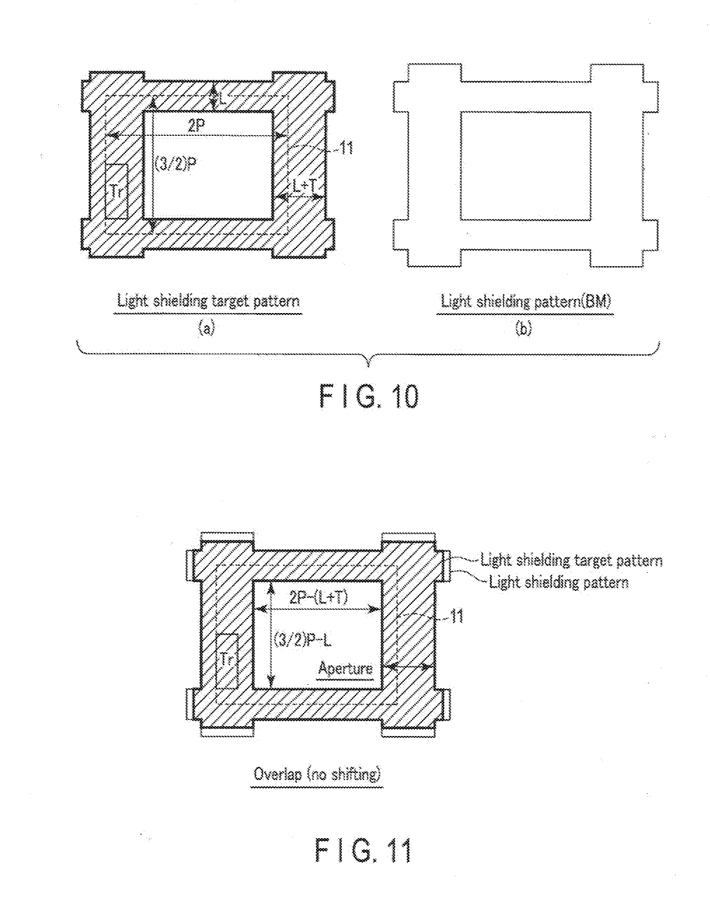

Next, the alignment shift of the black matrix BM in the subpixels 11 will be described. FIG. 10 is a drawing to explain an example of a light shielding target pattern and a light shielding pattern in the subpixels 11. FIG. 10(a) shows a light shielding target pattern. FIG. 10(b) shows a light shielding pattern consisting of the black matrix BM. A light shielding width of the long side to shield a wiring part is denoted as L. A switching transistor Tr is provided on the short side, for example. An increment in the light shielding width to shield the switching transistor Tr is denoted as T, and a light shielding width on the short side to shield the wiring part and the switching transistor Tr is denoted as “L+T”. The light shielding target pattern is formed on a TFT substrate comprising a switching transistor Tr, for example. The light shielding pattern is formed on a color filter substrate (CF substrate) comprising a color filter, for example.

FIG. 11 is a drawing to explain when the light shielding target pattern in FIG. 10(a) and the light shielding pattern in FIG. 10(b) overlap without any shifting. The aperture area (a display area) becomes maximum if no alignment shift occurs. The aperture area shown in FIG. 11 can be expressed by “(2P−(L+T))·((3/2) P−L)”.

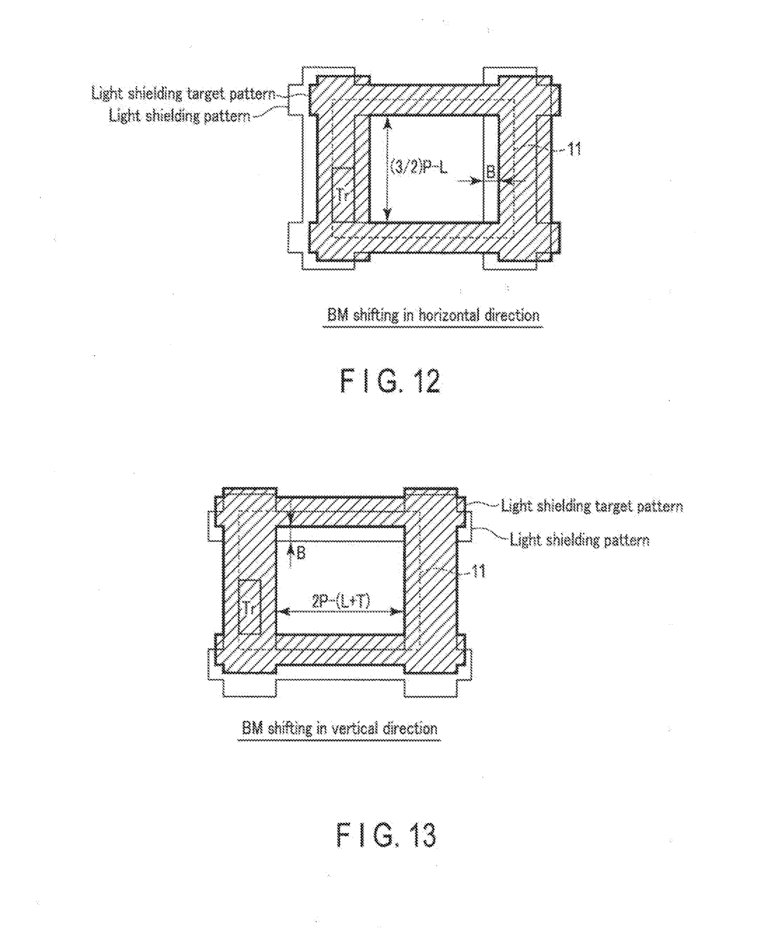

FIG. 12 is a drawing to explain when an alignment shift occurs in the horizontal direction (the black matrix BM is shifted in the horizontal direction) . The shifted amount of the black matrix BM is denoted as B. The decrement in the aperture area in FIG. 12 can be expressed by “((3/2)P−L)·B”.

FIG. 13 is a drawing to explain when an alignment shift occurs in the vertical direction (the black matrix BM is shifted in the vertical direction) . The decreased area of the aperture as shown in FIG. 13 can be expressed by “(2P−(L+T))·B”.

If the maximum of the shifted amount B of the black matrix BM is constant regardless of a direction of the shifting, the decreased area in the aperture is proportional with the area width of a subpixel orthogonal to the direction of the shifting; thus, the decreased area of the aperture becomes maximum when the direction of the shifting is the same as the direction orthogonal to the long side of the subpixel. Thus, the decreased area of the aperture will become larger in the comparative example shown in FIG. 6. On the other hand, in the present embodiment, the aspect ratio of the subpixel 11 is approximately 3:4; thus, the example shown in FIG. 13 illustrates a case where the decreased area of the aperture is maximum. Although there are some fluctuations in a ratio of the light shielding width L in the wiring part and the increment T in the light shielding width of the switching transistor to the pitch P, the maximum decreased area in the aperture in the present embodiment (FIG. 13) is reduced to approximately ½ to ⅔ in comparison to the structure in the comparative example (FIG. 6).

### [3. Structure of Display Apparatus]

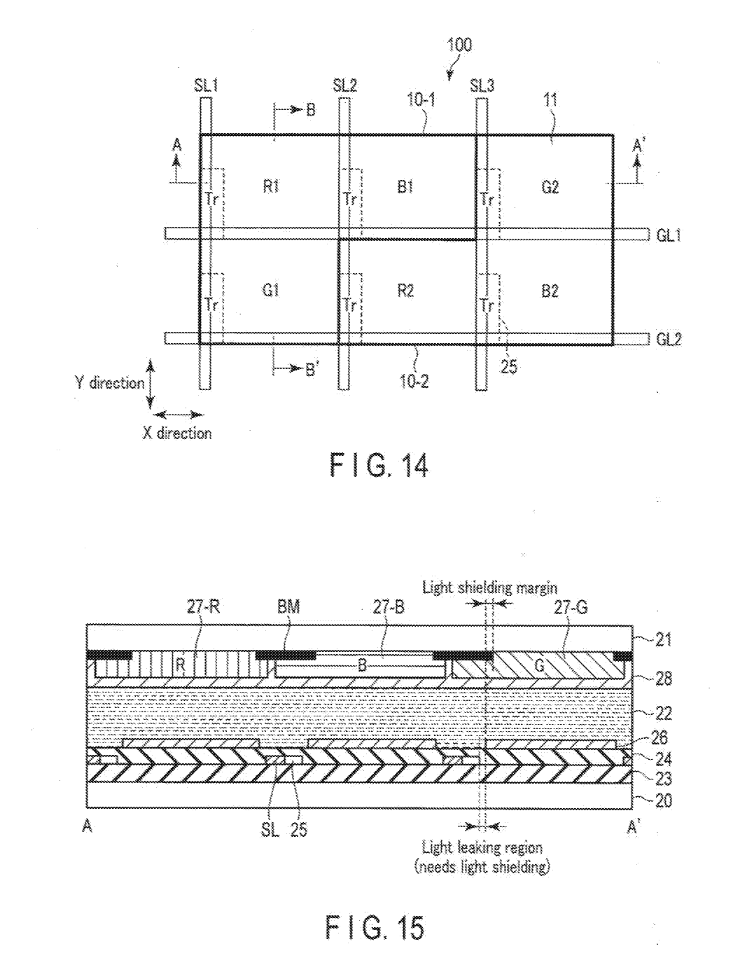

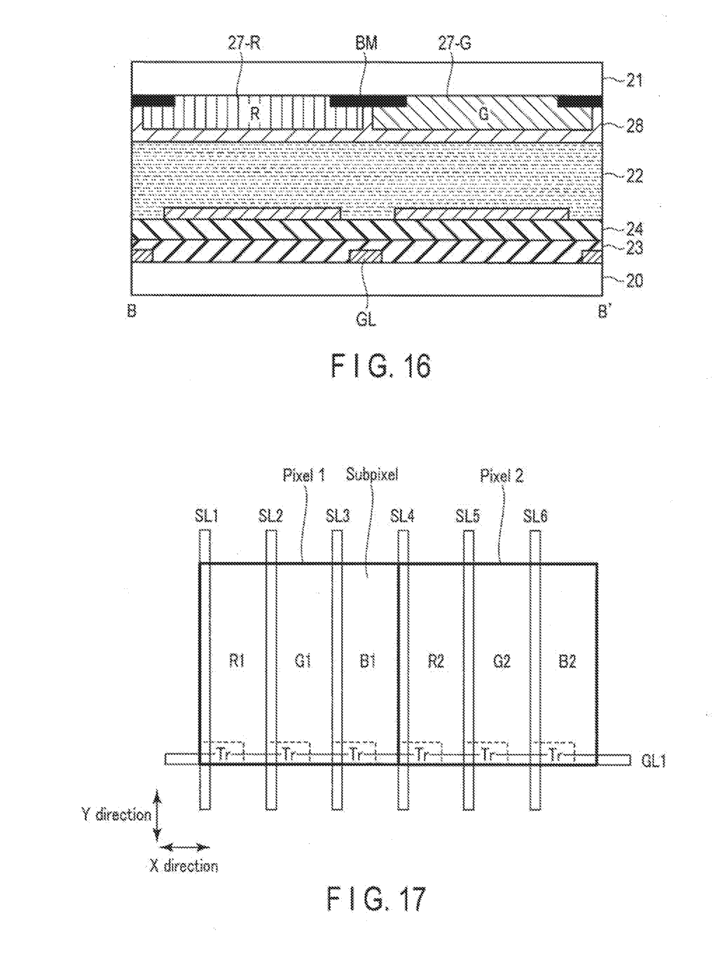

Next, the structure example of the display apparatus 100 will be described. FIG. 14 is a plane view of the display apparatus 100. FIG. 14 illustrates the display portion related to the two pixels 10-1 and 10-2. FIG. 15 is a cross-sectional view of the display apparatus 100 shown in FIG. 14 taken along line A-A′. FIG. 16 is a cross-sectional view of the display apparatus 100 shown in FIG. 14 taken along line B-B′.

Each of the pixels 10-1 and 10-2 consists of R, G, and B subpixels 11. The shape and the array of the pixels 10-1 and 10-2 and a plurality of subpixels 11 included therein are as described above and illustrated in FIG. 9.

The display apparatus 100 comprises a TFT substrate 20 on which a switching transistor and a pixel electrode, etc. are formed, a CT substrate 21 on which a color filter and a common electrode are formed and which is opposed to the TFT substrate 20, and a liquid crystal layer 22 which is held between the TFT substrate 20 and the CF substrate 21. Each of the TFT substrate 10 and the CF substrate 21 is made of a transparent substrate (e.g., a glass substrate).

The liquid crystal layer 22 is made of liquid crystal materials sealed by a sealing material (not shown) that adheres the TFT substrate 20 with the CT substrate 21. The optical characteristic of the liquid crystal material is changed by operating the orientation of the liquid crystal molecules in accordance with an electric field applied between the TFT substrate 20 and the CF substrate 21.

A plurality of scanning lines GL (scanning lines GL1 and GL2) extending in the X direction (the row direction) are provided on the TFT substrate 20 on the side of the liquid crystal layer 22. The scanning lines GL are arranged on the boundary portion of the two subpixels adjacent in the Y direction (the column direction) orthogonal to the X direction.

An insulating film 23 is provided on the plurality of scanning lines GL. A plurality of signal lines SL (including signal line SL1 to SL3) each extending in the Y direction is provided on the insulating film 23. The signal lines SL are arranged on the boundary of two subpixels 11 adjacent in the X direction.

The switching transistor (Tr) 25 is provided on the insulating layer 23. As the switching transistor 25, a thin film transistor (TFT) is used, for example. The switching transistor 25 is provided in the vicinity of the crossing region of the scanning line GL and the signal line SL. FIG. 15 shows a simplified version of the switching transistor 25. In reality, the switching transistor 25 comprises a gate electrode electrically coupled to a scanning line GL, a semiconductor layer (e.g., amorphous silicon), a gate insulating film provided between the gate electrode and the semiconductor layer, a first electrode contacted with the semiconductor layer and electrically coupled to a signal line, and a second electrode contacted with the semiconductor layer and electrically coupled to a pixel electrode (subpixel electrode).

The insulating film 24 is provided on the signal lines SL. A plurality of subpixel electrodes 26 corresponding to the plurality of subpixels 11 are provided on the insulating film 24.

The color filter 27 is provided on the CF substrate 21 on the side of the liquid crystal layer 22. The color filter 27 comprises a plurality of red filters 27-R, a plurality of green filters 27-G, and a plurality of blue filters 27-B. Each color filter is provided to correspond to one subpixel 11. The shape and the array of each of the red filter 27-R, the green filter 27-G, and the blue filter 27-B are the same as those of the R, G, and B subpixels 11 shown in FIG. 11.

The black matrix BM for shielding light is provided on the boundary of the red filter 27-R, the green filter 27-G, and the blue filter 28-B. In other words, the black matrix BM is formed in a mesh pattern. As described above, the black matrix BM has a function of shielding light in a light shielding target pattern including the wiring and the switching transistor. As showed in FIG. 15, the region between the subpixels electrode 26 and the switching transistor 25 (or the signal lines SL) is a light leaking region, which needs to be shielded by the black matrix MB. The region where the black matrix BM and the subpixel electrode 26 overlaps is a light shielding margin.

A common electrode 28 is provided on the color filter 27 and the black matrix BM. The common electrode 28 is formed entirely over the display portion of the display apparatus 100.

A transparent electrode constitutes each of the subpixel electrode 26 and the common electrode 28, using, for example, ITO (indium-tin oxide) . Silicon nitride (SiN) , for example, is used for the insulating films 23 and 24. Chromium (Cr), molybdenum alloy, or aluminum alloy is used for the scanning lines GL and signal lines SL, for example.

FIG. 17 is a plane view of the display apparatus according to the comparative example (stripe array/mosaic array). FIG. 17 shows two pixels (pixel 1 and pixel 2) extracted.

One scanning line GL and six signal lines SL1 to SL6 are provided in the two pixels. A switching transistor Tr is provided in the vicinity of the crossing region of the scanning line GL and the signal line SL. Thus, in the comparative example, one scanning line and six signal lines, seven lines in total, are required for two pixels.

In contrast, in the present embodiment, as shown in

FIG. 14, the pixels 10-1 and 10-2 can be configured with two scanning lines and three signals lines, that is, five lines in total.

### [4. Effect]

As described in detail in the above, according to the first embodiment, the aspect ratio of the subpixels 11 is approximately 3:4; accordingly, the actual aspect ratio of the aperture will be close to 1:1. Thus, anisotropy of the aperture ratio variation due to the alignment shift of the black matrix BM can be mitigated, and the amount of maximum decrement in the aperture ratio due to the alignment shift of the black matrix BM can be reduced in comparison to a subpixel with the aspect ratio of approximately 3:1 (the comparative example).

Since the subpixel 11 has the aspect ratio of approximately 3:4, the perimeter of the subpixels in the same-sized area will become ⅞ shorter than the subpixel with the aspect ratio of 3:1. Thus, the area occupied by the wiring can be reduced, thereby improving the aperture ratio.

Furthermore, the number of scanning lines is twice as much and the number of signal lines is half as much as those included in a display apparatus with a common stripe array. For example, in a display apparatus having n (rows)×n (columns) pixels, the number of signal lines in the column direction is 3n, and the number of the scanning lines in the row direction is n; thus the total number of the lines is 4n. In contrast, in the present embodiment, the number of signal lines is 3n×1/2, and the number of scanning lines is n×2; thus, the total number of the wiring is 3.5n, which is less than that in the comparative example. If a display apparatus is driven by a driver LSI, the size of the LSI (chip area) is greatly dependent on the number of connection terminals, that is, the number of lines in the wiring. Since the price of LSI is more or less proportional to the size, cost reduction is possible by reducing the total number of lines in the wiring.

### Second Embodiment

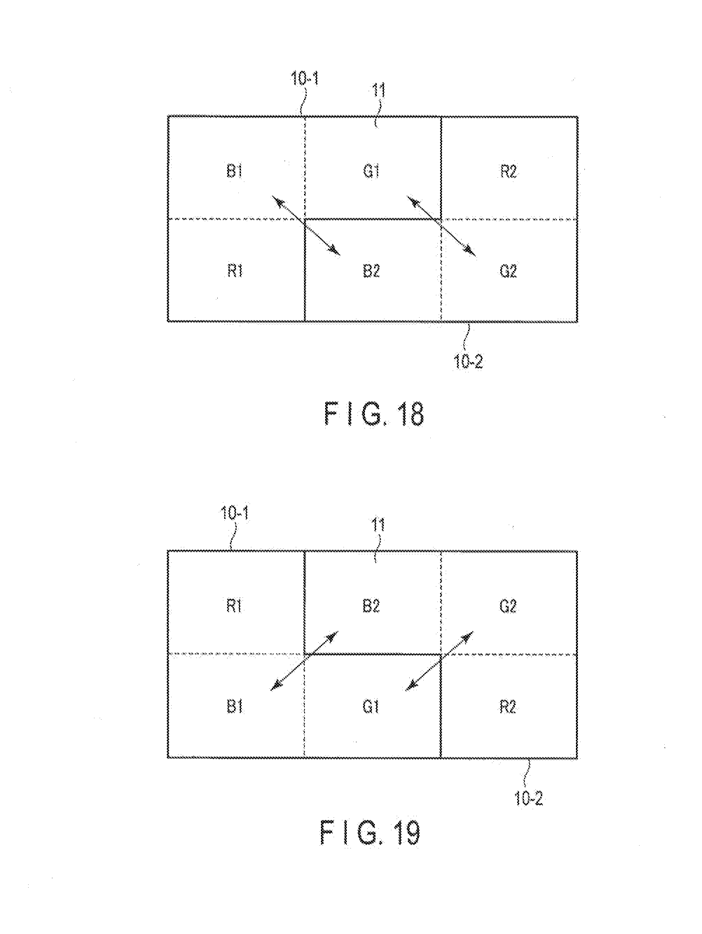

The second embodiment is an embodiment wherein the color arrangement of the subpixels is changed. FIG. 18 is a drawing to explain the shape and the array of a plurality of pixels 10 according to the second embodiment. FIG. 18 shows two pixels (pixel 10-1 and pixel 10-2) extracted.

Like the first embodiment, the rectangle formed by combining the L-shaped pixels 10-1 and 10-2 is a repetition unit in the second embodiment. In the pixels 10-1 and 10-2 which constitute a repetition unit, the blue subpixels 11-B1 and 11-B2 are arranged adjacent in a diagonal direction, and the green subpixels 11-G1 and 11-G2 are arranged adjacent in a diagonal direction. Red subpixels 11-R1 and 11-R2 are arranged diagonally in the remaining corners of the rectangle.

Unless changing the shape of the L-shaped pixels, the arrangement of the R, G, and B subpixels in the pixel is applicable to patterns other than the patterns illustrated in FIGS. 9 and 18. To apply this particular arrangement of the subpixels to other patterns, a pair of subpixels indicated by the arrow in FIG. 18 needs to be of the same color. Although a color combination would not effect the performance, an image signal applied to a signal line should be changed in accordance with this color arrangement.

### Third Embodiment

In the third embodiment, the direction of the L-shaped pixels is changed. FIG. 19 is a drawing to explain the shape and the array of a plurality of pixels 10 according to the third embodiment. FIG. 19 shows two pixels (pixel 10-1 and pixel 10-2) extracted.

The L-shaped pixels 10-1 and 10-2 in the third embodiment are configured by changing the directions of the L-shaped pixels 10-1 and 10-2 in the first embodiment. Specifically, the pixels 10-1 and 10-2 in the third embodiment are arranged symmetrically with those in the first embodiment with respect to the horizontal axis.

Like the first embodiment, the rectangle formed by combining the L-shaped pixels 10-1 and 10-2 is a repetition unit in the third embodiment. In the pixels 10-1 and 10-2 which constitute a repetition unit, the blue subpixels 11-B1 and 11-B2 are arranged adjacent in a diagonal direction, and the green subpixels 11-G1 and 11-G2 are arranged adjacent in a diagonal direction. Red subpixels 11-R1 and 11-R2 are arranged diagonally at the remaining corners of the rectangle.

In the third embodiment, the direction of a pair of the subpixels of the same color diagonally adjacent (the direction indicated by the arrow in FIG. 19) is different from the first embodiment. Furthermore, in the third embodiment, a combination of subpixel colors can be changed, like the second embodiment .

In each of the above-described embodiments, the color filter 27 is formed on the substrate 21 on which the common electrode 28 is formed; however, the present invention is applicable even when the color filter 27 is formed on the TFT substrate 20. Herein, a liquid crystal display apparatus 100 is described as an example of the display apparatus 100; the above-described embodiments may be applicable to various display apparatuses that adopt R, G, and B subpixels and a scheme of driving active elements provided in subpixels by wiring lines arranged in a matrix, such as an organic electroluminescence (EL) display apparatus, a plasma display, or an electronic paper.

The present invention is not limited to the embodiments described above, and can be embodied by modifying constituent elements without departing from the gist of the invention. In addition, the above embodiments include inventions of various stages, and various inventions can be formed by proper combinations of a plurality of constituent elements disclosed in one embodiment or proper combinations of constituent elements disclosed in different embodiments. When, for example, the problems to be solved by the present invention can be solved and the effects of the invention can be obtained even if several constituent elements are omitted from all the constituent elements disclosed in each embodiment, an embodiment from which these constituent elements are omitted can be extracted as an invention.

What is claimed is:

1. A display apparatus comprising:
a first pixel and a second pixel, each having subpixels of three colors, red, green, and blue,
wherein six subpixels included in the first and second pixels are arranged in two rows by three columns, and constitute a repetition unit to constitute a display portion,
an aspect ratio of a vertical length to a horizontal length of the subpixel is approximately 3:4, and
an aspect ratio of a vertical length to a horizontal length of the repetition unit is approximately 1:2.

2. The display apparatus according to claim 1, wherein
the repetition unit comprising the first and second pixels is rectangular, and
each of the first and second pixels has an L-shape.

3. The display apparatus according to claim 1, wherein a plurality of subpixels are arranged in such a manner that subpixels of the same color in the repetition unit are not arranged consecutively in each of a row and a column.

4. The display apparatus according to claim 1, further comprising a black matrix for shielding light provided in a boundary of subpixels.

5. The display apparatus according to claim 1, further comprising:
two scanning lines are provided in correspondence with the two rows of subpixels; and
three signal lines are provided in correspondence with the three columns of subpixels.

6. A color filter having a shape and an array in correspondence with the six subpixels recited in claim 1, and including red filters, green filters, and blue filters.
